(19) United States
(12) Patent Application Publication
(10) Pub. No.: US 2008/0033641 A1
(43) Pub. Date: Feb. 7, 2008

(54) METHOD OF GENERATING A THREE-DIMENSIONAL INTERACTIVE TOUR OF A GEOGRAPHIC LOCATION

(76) Inventor: Michael J. Medalia, Royal Oak, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/782,979

(22) Filed: Jul. 25, 2007

Related U.S. Application Data
(60) Provisional application No. 60/833,014, filed on Jul. 25, 2006.
(60) Provisional application No. 60/915,565, filed on May 2, 2007.

(51) Int. Cl. G01C 21/32

(52) U.S. Cl. 701/209

(57) ABSTRACT

A method of the present invention provides a user with an interactive virtual representation of a geographic location expressed to the user through a three-dimensional or a two dimensional representations and combination thereof generated by a system controlled by an operator. The method creates an interactive virtual tour of the geographic location by correlating a two-dimensional map with a three-dimensional representation of an interactive model to allow the user to synchronously navigate through the two-dimensional map and the interactive model in different directions.

### RELATED APPLICATIONS

This non-provisional application claims priority to provisional application Ser. Nos. 60/833,014 filed on Jul. 25, 2006 and 60/915,565 filed on May 2, 2007 and incorporated by reference herein in its entirety.

### FIELD OF THE INVENTION

The subject invention relates generally to information gathering applications and, more particularly, to computer systems used to navigate virtual environments.

### BACKGROUND OF THE INVENTION

Virtual reality allows a user to interact with a computer-simulated environment, displayed either on a computer screen or through special stereoscopic displays. Typically, the users interact with a virtual environment either through the use of standard input devices such as a keyboard and mouse, or through multimodal devices such as the wired glove, the headsets, the Polhemus boom arm, and omnidirectional treadmill to experience the simulated environment, which can be similar to the real world.

The art of virtual navigation is replete with various systems and methods. Some of these methods are taught by the U.S. Pat. No. 6,388,688 to Schileru-Key; U.S. Pat. No. 5,874,956 to LaHood and the United States Application Publication No. 20010034661 to Ferreira. Other prior art applications, such as, for example, virtual reality” tool are widely used in a real estate industry. This web-based tool offers panoramic images laced into a viewer such as QuickTime player in which the viewer rotates an image 360 degrees, such as, for example, a room in a house to enhance the realism.

Another application, known as VuPOD, was created by Phoenix-based research and design company. Using this device, a prospective buyer can request the images of a property for sale and see it in the VuPOD. The viewer is immersed in a full 360 degree image that surrounds them, complete with floor plans of the property so the viewer can tell where the room is in relation to the rest of the property. The current trend in the virtual reality applications is to create and improve a fully immersive and integrated experience. A drawback of the some of the prior art applications relates to headaches due to eye strain, caused by the headsets, which negatively impacts the user's health.

Another prior art device is provided by Google Earth™. This device allows the user to view the exterior of city blocks without allowing the access into various establishments located in the city. The three-dimensional images are generated and a vehicle equipped with several cameras moves along streets of the city capturing images surrounding the vehicle as it moves. The device provides limited applications and does not allow the user to access the interior of the establishments located along the streets.

Although the prior computerized systems and methods relating to the virtual reality applications utilizing a two-dimensional interactive mapping technology and a three-dimensional interactive modeling technology are currently used in various industries, an opportunity remains for a method of generating a three-dimensional interactive tour of a user-selected geographic location by combining two-dimensional interactive mapping technology with three-dimensional interactive modeling technology into an interactive virtual environment capable of being accessed using the internet to eliminate one or more problems associated with the prior art systems and methods.

### SUMMARY OF THE INVENTION

A method of the present invention employs a system adaptable for providing users with an interactive virtual representation of at least one geographic location including and not limited to various commercial and non-commercial establishments such as, for example, shops, restaurants, offices, museums, parks, and the like, expressed to the user through a three-dimensional and a two dimensional representation and combination thereof generated by a system controlled by an operator. The method of the present invention generates a three-dimensional interactive tour of a user-selected geographic location by combining a two-dimensional interactive mapping technology application, a three-dimensional interactive modeling technology application and a user interface. The two-dimensional interactive mapping technology application includes and is not limited to any 2-D global mapping protocol, such as, for example, API, i.e., Google Maps™, which permits interactive control and responds to the user's instructions. The three-dimensional interactive modeling technology application includes and is not limited to any low and/or high polygon count 3-D interactive modeling application capable of supporting realistic photo textures.

A three dimensional model process is created where the three-dimensional model has a realistic photo texture and is created to simulate real-world destinations, locations, or attractions, created from digital or digitized images of any geographic location. Computer code interconnects the two applications and the user interface. The aforementioned user interface includes a two-dimensional overhead map viewing window, a three-dimensional viewing window and a database of destinations information all connected with encoding to enable response to user instruction and being accessible using any known communication protocol including the internet. The index of destinations includes a plurality of destinations which are predetermined geographic locations. The two-dimensional overhead map and the three-dimensional viewing window and the index of destinations may be concurrently displayed on the user interface, as desired by the user. The selection of a destination from the index of destinations initiates icon placement on the two-dimensional overhead map and display of an automated flight path tour in the three-dimensional viewing window to the selected destination. The computer code provides a means of communication between the two applications and the user interface such as, but not limited to, movement tracking and textual and visual information exchange.

Information is exchanged between the two-dimensional overhead map and the three-dimensional viewing window that may also take the form of a “you are here” (YAH) reference locater whereby movement within the three-dimensional viewing window is tracked by the YAH tool on the two-dimensional overhead map, and conversely movement of the YAH reference locater on the two-dimensional overhead map controls views within the three-dimensional viewing window. A detailed interior function is provided where selection of a destination from the index of destinations initiates a tour of the selected destination, which includes 360 degrees panorama photographs of selected locations of a particular business in addition to textual information such as price lists, menus, product offerings etc.

An advantage of the present invention is to provide a virtual community to enhance the realism thereby immersing the users in the destination environment, wherein the destinations are searched geographically for the first time while providing a “real world” experience. For example, one can conduct a search for a particular restaurant or any restaurant or other establishment proximate to the restaurant being searched.

The method of the present invention improves the prior art systems and improves the user's knowledge of general or specific geographic location using the two-dimensional map frame while using the three-dimensional model frame to view more detailed information from positions ranging to ground level perspective to any number of horizon viewing perspectives.

Both business-to-business and business-to-consumer, customers of the virtual cities service may be varied and many. Large conglomerates and family-owned businesses may both have their place in the virtual city service's online community. Individual users with interests as diverse as traveling, shopping, computer-gaming, and simplifying the business of their daily lives may come to rely on the virtual city service as their first and most-trusted venue on the web. Large vendors may make use of the virtual city service to generate incremental sales and to provide their customers far greater ease of checkout and payment—without losing control of the customer payment information. Small to medium-sized vendors may make use of the virtual cities service to make a presence on the web as part of a large, robust, dynamic community within which they will enjoy economies of scale and access to unique and valuable marketing data.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a flowchart of a method for generating a three-dimensional interactive tour in accordance with the subject invention;

FIG. 2 is an illustration of a user interface in accordance with the subject invention;

FIG. 3 is an illustration of a street model in accordance with the subject invention;

FIG. 4 is an illustration of the user index which initiates a 3-D guided tour in accordance with the subject invention;

FIG. 5 is an illustration of the line of site indicator referencing between applications in accordance with the subject invention,

FIG. 6 is an illustration of a detailed interior function with 360 degree panoramic image in accordance with the subject invention;

FIG. 7 illustrates a search destination/browse destination on a destination presentation page of an alternative embodiment of the present invention;

FIG. 8 is an illustration of additional uses of the search destination/browse destination on a destination presentation page;

FIG. 9 is an illustration of a destination, creation and upload page in accordance with another alternative embodiment of the present invention;

FIG. 10 is an illustration of an administration tool method page;

FIG. 11 is an illustration of a web portal system page of the present invention; and

FIGS. 12 and 13 show other alternative applications of the present inventive system and method.

### DETAILED DESCRIPTION OF THE PREFERRED EMBODIMENT

Referring to the Figures, wherein like numerals indicate like or corresponding parts, a three-dimensional interactive tour of a geographic location of the present invention is generally shown at 10. The method 10 combines an interactive two-dimensional digital mapping technology with three-dimensional interactive models into an interactive virtual environment that can be accessed using the internet. The method 10 is capable of being accessed using the Internet. The interactive models are created to simulate real-world destinations, locations, or attractions and are formed from at least one of low or high polygon count, three-dimensional models having realistic photo textures, and a combination thereof.

The method 10 utilizes a system of the present invention. The system includes and is not limited to a hardware may be any suitable user hardware, software, such as, for example, a personal computer with web-browsing software that may be used by users of the inventive system to navigate among a virtual real world destinations via communications network. Alternatively, user hardware may be a personal computer with image-capturing hardware and suitable image-processing software. Information database is stored in a data server. Alternatively, additional servers are provided to store information database. Information database may is to store user information included and not limited to names, addresses, telephone numbers, credit card information, bank account information, or any other suitable payment information.

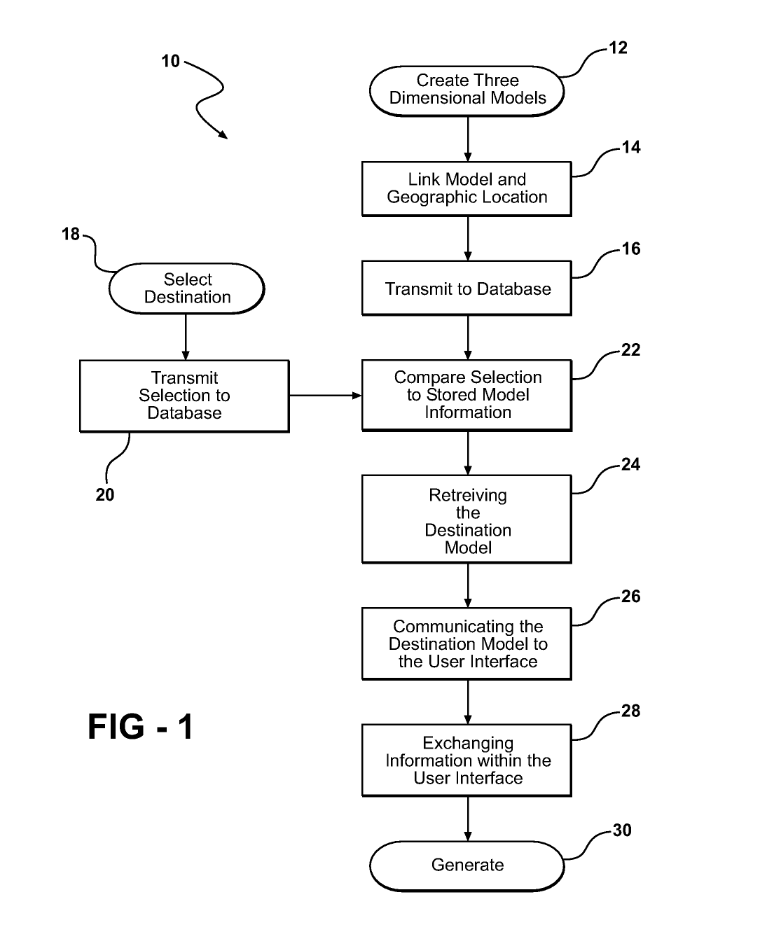

FIG. 1 illustrates a flowchart of the method 10 presenting illustrating the steps for generating a three-dimensional interactive tour. Initially, a three-dimensional model (the model) of a geographic location is created, as shown at 12. The model is created by compiling and/or assembling multiple image sources, such as, for example, photographs, film, video. Those skilled in the art will appreciate that the imaging sources may have various other expressions, such as, for example, a slide show of still images and videos, animation, or any other suitable form of imagery. Any geographic location may be divided into segments or units representing an intersection, a section of a street, a section of an avenue or a road, or any other part of the geographic location including and not limited to a commercial establishment and a non-commercial establishment, such as a restaurant, a museum, an office building, a movie theater, a market, and any other location across the world without limiting the scope of the present invention. The location also includes both interior and exterior of the geographic location. The model may be created by an operator of the system, by the user, utilizing the system on commercial or non-commercial bases or by combined efforts of both user and the operator. The models are created by the operator and the user by any suitable image capturing devices, such as a 180.degree. digital camera, 360.degree. digital camera, ordinary digital camera, film-based camera, video camera, or any other suitable image capturing device without limiting the scope of the present invention.

Alluding to the above, the operator and the user may create the model by utilizing hard-copy photographs by scanning the photograph through a scanner and converting the photograph through a software to the three-dimensional model. As the model is created, the system links the model and the geographic location at 14, and transmit the linked model and geographic location to the aforementioned database at 16 stored in the server and any other a computer/information processor or other data storage medium. At this point, the user can select a destination at 18 and transmit the selection to the database at 20. At this point, the computer or other information processor compares the user selection to the stored model information at 22. Provided that the selected destination is available from the database, whether introduced thereto by the operator, other users, and combination thereof, the computer or other information processor retrieve the destination model at 24. The computer or other information processor communicates the destination model to the user interface at 26. At this point, there can be an exchange of information with the user interface at 28. As a result of this exchange, additional specific images (e.g., specific areas of locations, businesses and/or the like) can be generated at 30.

As previously described, the present invention includes the aforementioned user interface that provides a comprehensive display of a navigable virtual environment. The navigable virtual environment has the interactive two-dimensional maps, interactive three-dimensional models, a user selectable index, which includes a plurality of destinations, and a user navigation interface. The navigable virtual environment is created in response to the user's selection of a particular geographic location from the geographic region displayed as an interactive two-dimensional map or input using the interactive three-dimensional models, index or navigation interface.

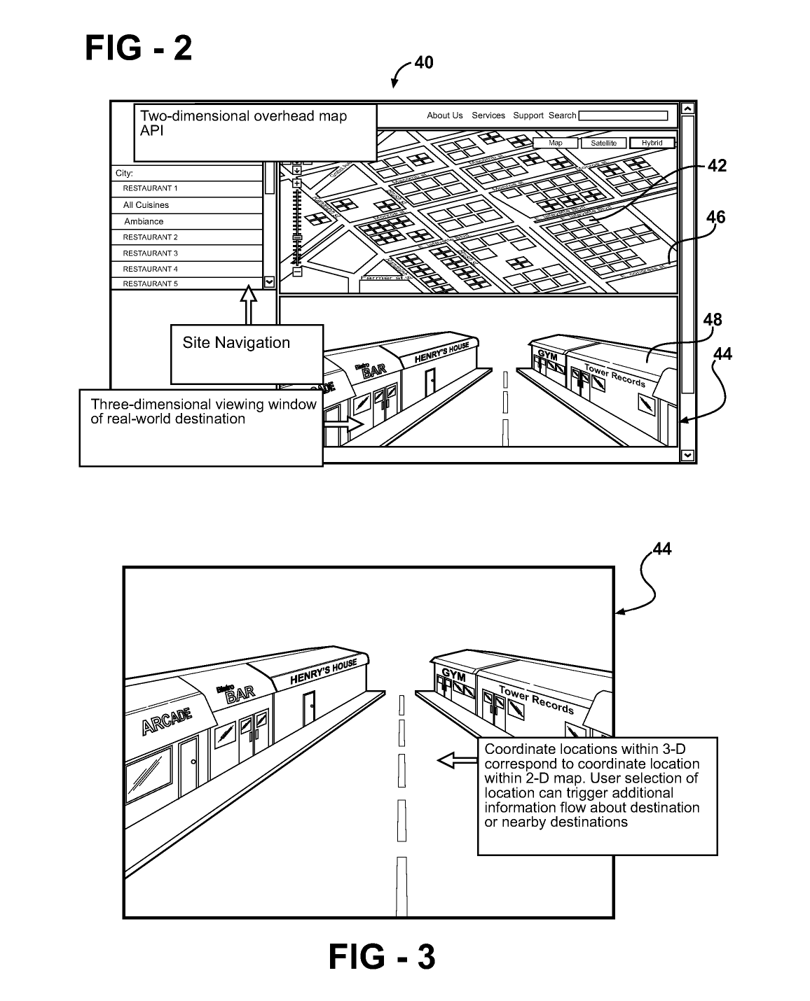

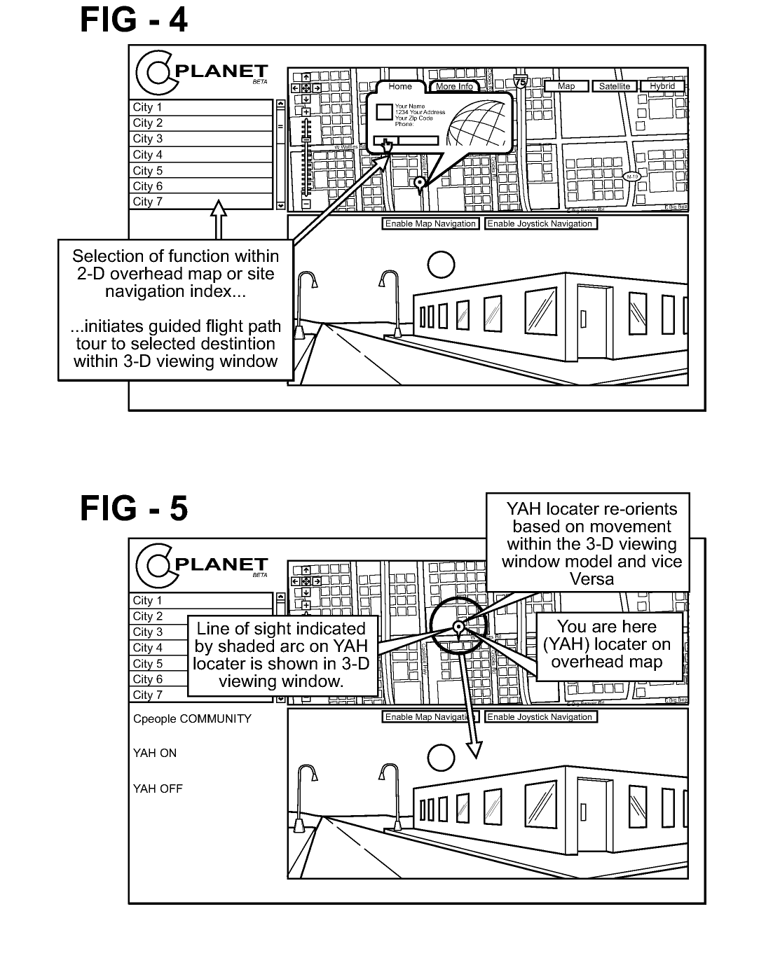

FIG. 2 illustrates the user interface, as generally shown at 40. The user interface uses the two-dimensional global mapping application protocol (or API, e.g., Google Maps™), generally indicated at 42 that permits interactive control. An interactive three-dimensional low polygon count modeling application, as shown at 44 in FIGS. 2 and 3, supports realistic photo textures, and/or a communications method linking the applications to the site navigation index so as to enable the communication of information between the applications for the purposes of movement tracking and textual and visual information exchange, as further shown in FIG. 3. This includes the presentation of the two-dimensional map 46 on the same screen as the three-dimensional model viewing window 48, as best shown in FIG. 2. The users select from an index of destinations, as mentioned above, whereby the selection of any business from the index initiates both the placement of an icon on the two-dimensional map and an automated flight path tour to the business location within the three-dimensional model, as best shown in FIG. 4.

Once the model information is received by the user interface, the method further includes an exchange of information between the two-dimensional and three-dimensional applications and may be visually represented by a line of sight indicator icon on the two-dimensional map, as best shown in FIG. 5. The line of sight indicator icon can take the form of a “you are here” (YAH) reference locater whereby movement within the three-dimensional model is tracked by the YAH tool in the two-dimensional application. Likewise, movement of the YAH reference locater within the two-dimensional application controls views within the three-dimensional model.

In one aspect of the present invention, the method also aspect of the present invention, the two-dimensional and three-dimensional frames are synchronized in a way to provide a selection of active controls within the two-dimensional frame through user input, which initiates automated flight paths within the two-dimensional frames. An example might include, but is not limited to, the selection of an icon that has populated the two-dimensional frame based on the user input from a selection within the user index. A “go there” selection within the icon initiates an automated flight path within the three-dimensional model to place the point of view in the three-dimensional frame at the selected destination.

Another aspect of the present invention includes a geographic reference system that references points in two planes (e.g., longitudinal and/or latitudinal) for the two-map and relates this location to the counterpart location in the three-dimensional coordinate system (e.g., longitudinal, latitudinal, and/or z axis). As user input is received for specific coordinate positions, either via index selection or through movement within the two-dimensional map or the three-dimensional model, various information are conveyed to the user from the computer database about the destination associated with that coordinate position or with destinations nearby.

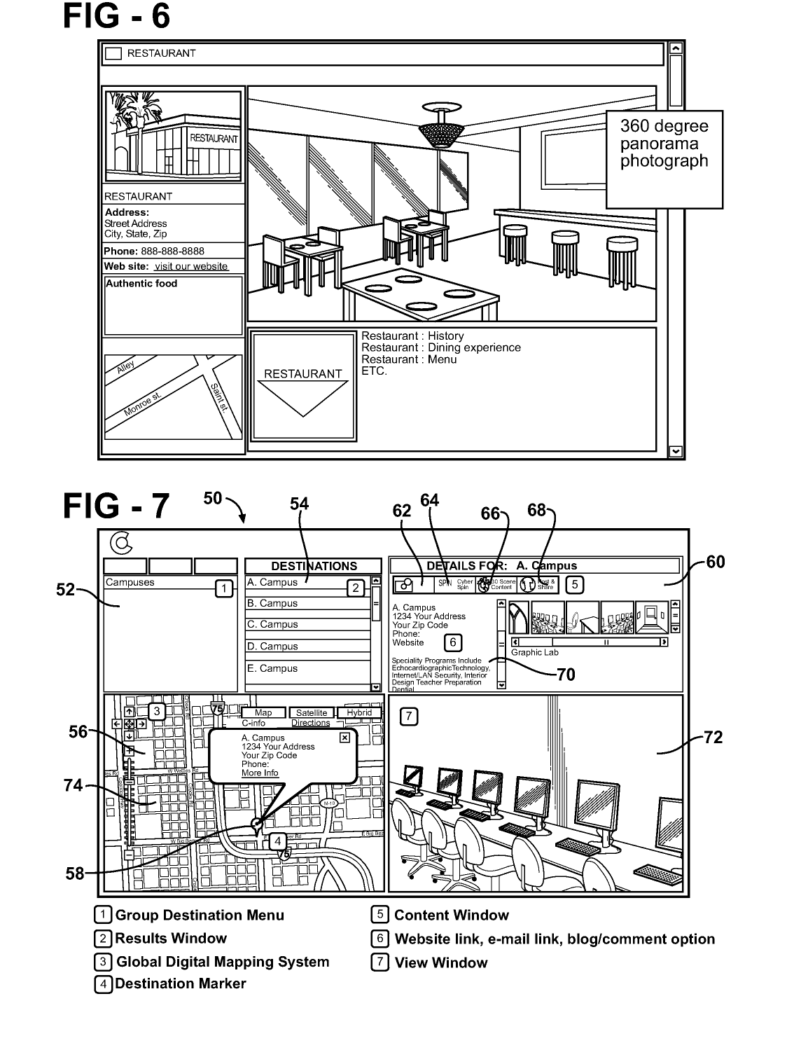

A detailed interior function is provided to the user by the method as shown in FIG. 6. The detailed interior function allows the user to select the destination from the index of destinations and to initiate a tour of the selected destination, which includes and is not limited to 360 degree panorama photographs of selected locations of a particular business in addition to textual information such as price lists, menus, product offerings, and/or the like, as shown in FIG. 6. The user may link a camera installed at the user's business to the system with internet and other suitable protocols to allow other users to view the interior and exterior of the selected business.

FIG. 7 illustrates destination presentation page method including a user exploration and discovery system. An illustration of a search destination/browse destination on a destination presentation page is shown at 50 and includes a group destination menu 52, a results window 54, a global digital mapping system 56, a destination marker 58. The destination presentation page 50 further includes a content window 60 presenting several options, including and not limited to a photo gallery option 62, which presents to the user multitude of photos associated with the destination, a cyber spin option 64, a 3-D Scene Content 66, and post and share option 68, which allows the users to post and share information with other users. All of the aforementioned options are accessible and implemented by both the users and the operator, i.e. webmaster of the present invention. A website link, email link, and a blog/comment option 70 is provided by the system to allow the users to post their comments to be shared by other users. A viewing window 72 allows the user to view the three-dimensional model, a video image, and/or the photos of the selected destination.

Alluding to the above, the user selects a destination, such as for example a school campus, from the results window 54. The destination latitude and longitude coordinates are sent to the global digital mapping system 56 and plotted with the destination marker 58 corresponding to its venue. The global digital map 74 is centered and zoomed on the destination. Any descriptive content of the destination is sent to the content window 60. Any upgraded content assigned as the initial viewing window content is sent to the viewing window 72. The user then selects from the content window 60 to send uploaded descriptive content to the viewing window 72. The user then click on a website link at the website link, email link, and a blog/comment option 70 associated with the destination to open another browser window and examine its site. The user then clicks an email contact associated with the destination to open an email application. The user then clicks on the blog/comment option 70 to add/read any user-uploaded comments associated with the destination.

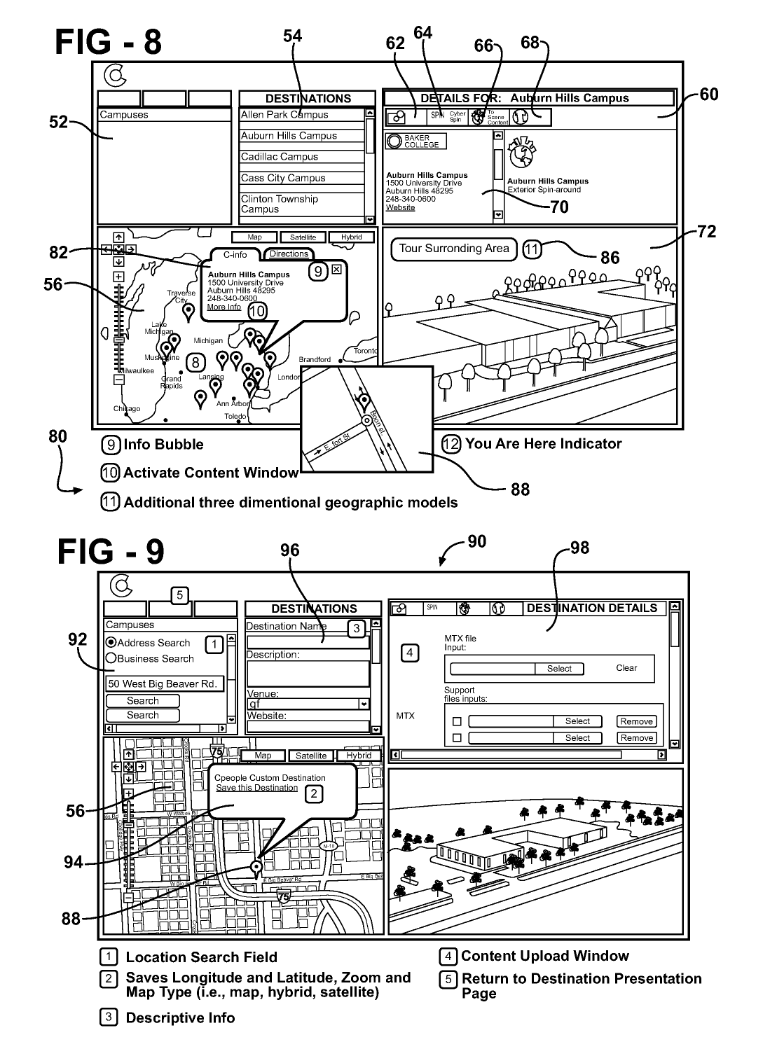

Referring now to FIG. 8, an illustration of additional uses of the search destination/browse destination on a destination presentation page is shown at 80. In this view, upon completing viewing of the content window 60, the user then has the option to select from dynamically placed destination markers on the map showing other destinations saved to the application database within a given proximity to the current destination. The destination markers correspond to the destination's associated venues. Clicking another destination marker will open an “info” bubble 82 with a preview of the destination's descriptive content. To send the destination content to the content window 60, the user clicks the more info link on the info bubble 82. For a three dimensional environment, if the current destination has a geographic three dimensional environment associated to it, and there are additional three dimensional geographic models adjacent to the active three dimensional model, a tour surrounding area button 86 will appear in the viewing window 72 to allow the user to navigate through the three dimensional environment with more three dimensional models downloading from the application database as the user's geographic position enters the three dimensional model geographic position.

As the user changes their position in the three dimensional environment, a you are here indicator 88 displays on the digital mapping system 56, marking the user's position from an aerial perspective in a synchronized movement with the three dimensional environment camera and displaying the rotation of the users line-of-sight relative to north, south, east and west. Also, as the user changes position, more destination markers will appear on the global digital mapping system 56 as the user's geographic position enters their proximity, at which time the user clicks on the destination marker 58, which animates the camera in the three dimensional environment to the destination's three dimensional store front and populate the content window with any descriptive content associated to the destination for the user to browse. The user continues this application until the user has explored all of the available adjacent three dimensional models to the original destination at which time the user starts the path all over again with a new search or browses a different location.

Referring to FIG. 9, an illustration of a destination, creation and upload page method page is generally shown at 90. The page 90 includes a location search field window 92, an option 94 that allows the user to save longitude and latitude, zoom and map type, a descriptive information window 96, and a content upload window 98. The primary user interaction and upload procedures are as follows. The user positions the global digital mapping system 56 e.g., by using the location search field window 92. The global digital map is centered and zoomed on the destination. The user then clicks the global digital map to mark custom destination via the destination marker. The info bubble 88 appears showing an option to save this destination (e.g., a link). By clicking save this destination, the system saves the current settings of the global digital mapping system (e.g., longitude and latitude, zoom and map type (e.g., map, hybrid, satellite and/or the like). The application then opens the descriptive info window 96, allowing the user to input information to describe the destination known as the descriptive info (e.g., name, description, venue, weblink, e-mail, logo, address, and/or the like). By clicking the save button, the system will upload the info to the application database. After saving the destination descriptive info, the user can then select an upload content button. The application then opens a form for the user to upload any combination of digital content used to describe the geographic destination (e.g., image gallery, 360 degree cyber spins, panoramic spins, third party tag content (YOUTUBE™, FLASH™, FLICKER™, photo galleries, three dimensional scene content, and/or the like), and/or the like. The content can be any medium the Web can deliver including the three dimensional, virtual real-time rendered scene. After completing the upload of the destination information and content, the user can choose to add the destination to a custom tour (by default, all destinations are stored in the all destinations window per user). The user then restarts the method to add another destination(s) or open the destination presentation page to view the destination they just created.

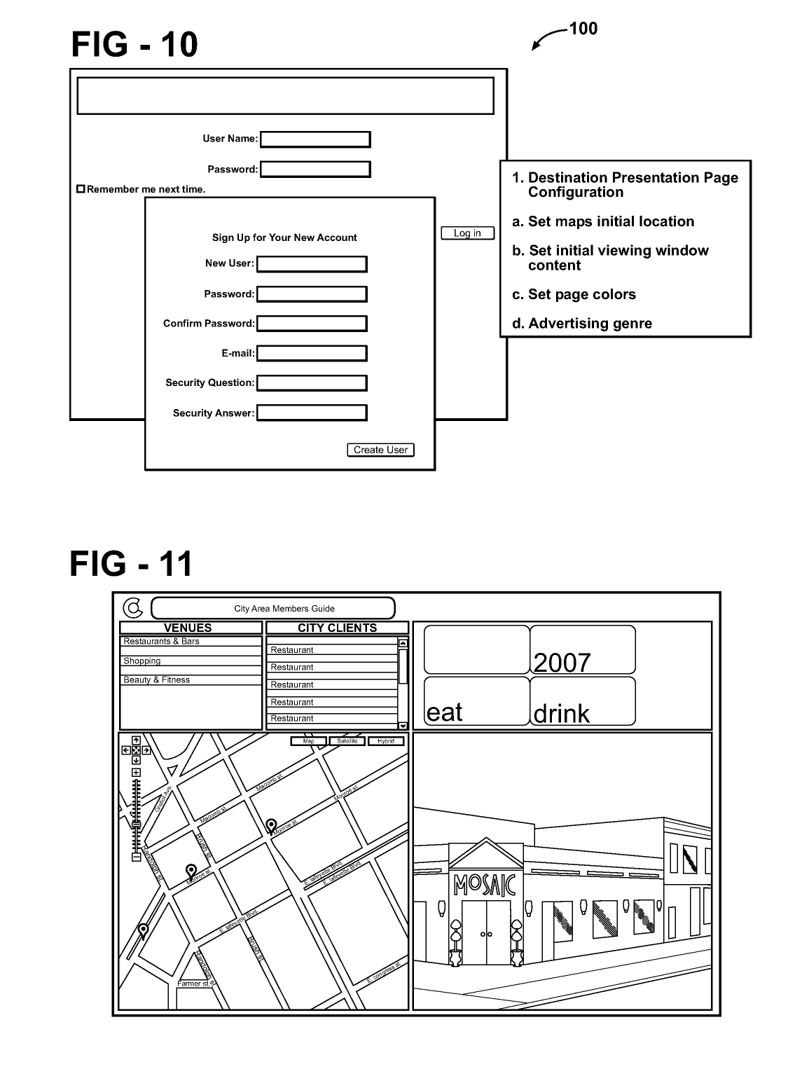

Referring to FIG. 10, an illustration of an administration tools method page is generally shown at 100, which allows for, among other things, a sign-up/log-in feature. A destination presentation page configuration system is provided for allowing one to; (1) set the maps initial location; (2) set the initial viewing window content; (3) set page colors; and (4) set an advertising genre. One of the destination content population tools includes forms to step the user through content browse, title; upload, import, tag, and/or the like. One of the invitation tools includes forms to allow the user to invite other users to see a destination, tour or browse their entire page, and/or the like. One of the upgraded account tools includes forms for upgraded fee based features (e.g., server space, and/or the like).

In accordance with another alternative embodiment of the present invention, reference is made to FIG. 11. In this embodiment, a web portal system is illustrated, including an information data exchange application (IDEA). The web portal, branded as Cplanet.com®, includes a global delivery system that provides a meeting place for the business community and Internet users to discover, explore, create and share information about real-world destinations. Content and destination information is dynamically populated and delivered via the Internet using the latest in client-side scripting and server-side application programming. Use of this technology ensures the ability to expand and incorporate new advancements as they arise. The Cplanet IDEA allows content to be automatically uploaded, categorized by location and venue, and identified by a location marker on the two-dimensional map.

Additional destination contact information and optional driving directions are also populated. Utilizing the client interface, businesses, organizations, groups, and individuals (e.g., anyone with Internet access) can view, search and populate Cplanet.com® with destination information and media. The ability to upload any data relative to the destination provides global Internet users with a centralized platform/portal to access and exchange information and media pertaining to any real world destinations. Cplanet's media viewing area is capable of delivering any type of rich media content including photo/photo gallery, 360° spin imported content (e.g., music, video, flash content, and/or the like), printable coupons, menu browser, conference/reception seating configurator, games, interactive educational content, and/or the like. The Cplanet IDEA has incorporated three-dimensional content to the list of media types it delivers. The users upload complete three-dimensional scenes to represent or compliment a real world destination. Cplanet will play a major role in the next evolution of the Web by giving it a third dimension.

The method and system of the present invention provide numerous advantages over the prior art systems and methods as set forth above. Built on the growing Web 2.0 platform and Online-Community concepts, Cplanet.com® is a secure web-based application allowing businesses and individuals to customize, build and publish a web-presence in mere minutes. This technology, which combines an interactive three-dimensional experience (e.g., similar to a video game) with the latest in two-dimensional digital mapping technology, offers Internet users both a street level and aerial perspective of a destination. This allows Internet users to virtually browse and familiarize themselves with the destination and explore surrounding businesses, services, and recreational offerings of the community, prior to their arrival.

Some of the features of the present invention include and are not limited to a single-click, which allows for free roaming throughout the three-dimensional model, Internet users can select destinations and download the information to a GPS for assistance during travel, all uploaded information can be viewed from a remote location (e.g., a Cplanet® TouchScreen Kiosk), with the future in mind, the three-dimensional content is already programmed to be delivered in hyper view (e.g., through the use of 3D goggles).

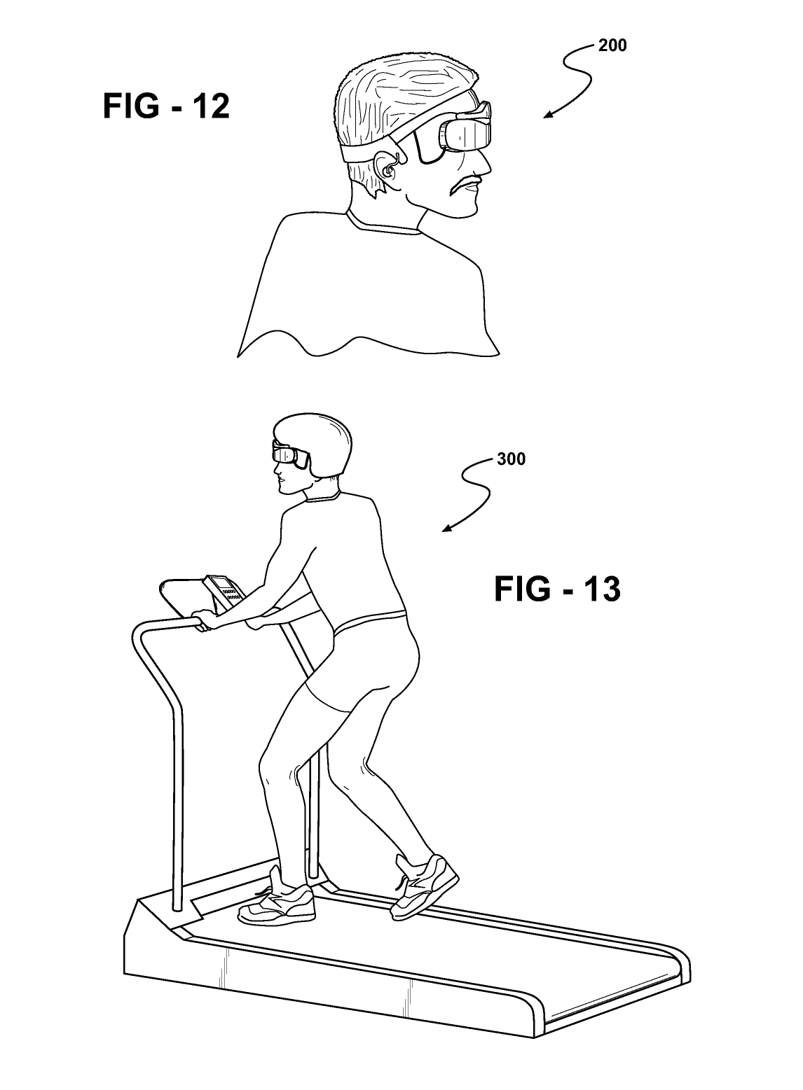

Web portals are the next evolution in Internet services (e.g., CompuServe, MSN, AOL), providing a more robust one-point access to a variety of content and core services, and ideally offering a single sign-on point. Portal content is dynamically managed through databases, application windows which allow the consistent organization of information and appearance making it easy to locate information of interest in relatively few clicks. Web portals offer advantages over home pages because they are customizable and personizable, and therefore capable of offering user-specific views. Common portal features not offered on home page include, without limitation, calendars, to-do lists, personal E-mail, searches (e.g., global, national, relative to location/surroundings, and/or the like), address books. FIGS. 12 and 13 illustrate alternative applications of the present invention generally shown at 200 and 300.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for providing an interactive virtual representation of a geographic location expressed through at least one of a three-dimensional and a two dimensional representation and combinations thereof generated by at least one of an operator and a user; said method comprising the steps of:
creating first images of the geographic location expressed to the user through a two-dimensional map to allow the user to navigate along the two-dimensional map in different directions;
creating second images of the geographic location expressed to the user through a three-dimensional representation allowing the user to selectively navigate along the three-dimensional representation in different directions whereby the three-dimensional representation is externally introduced to the system as an interactive model;
storing the first images and the second images in a searchable format; and
creating an interactive virtual tour of the geographic location by correlating the two-dimensional map with the three-dimensional representation of the interactive model enabling the user to conduct an internet search by geographic location thereby identifying places of interest associated with the geographic location depicted by the first and second images.

2. The method as set forth in claim 1, including the step of monitoring the geographic location and storing the interactive model at the geographic location.

3. The method as set forth in claim 1, further comprising the step of allowing the user to select at least one area of the geographic location to perform an action within the at least one area selected by the user.

4. The method as set forth in claim 4, wherein the step of selecting at least one area of the at least one geographic location is further defined by selecting an indoor location and an outdoor location and identifying actions associated with the indoor and outdoor locations available to the user.

5. The method as set forth in claim 4, wherein the step of selecting the geographic location is further defined by selecting at least one location of interest proximate the selected geographic location with the at least one location being a commercial establishment and a non-commercial establishment.

6. The method as set forth in claim 5, wherein the step of selecting at least one location of interest is further defined by displaying a virtual three-dimensional representation of the inside and the outside of the commercial establishment and the non-commercial establishment selected by the user.
